(19) United States
(12) Patent Application Publication
(10) Pub. No.: US 2008/0184288 A1
(43) Pub. Date: Jul. 31, 2008

(54) System and method for creating a customized video advertisement

(76) Inventor: Ken Lipscomb, Atlanta, GA (US)

Correspondence Address: MUSKIN & CUSICK LLC, 30 Vine Street, SUITE 6, Lansdale, PA, 19446, US

(21) Appl. No.: 11/935,997

(22) Filed: Nov. 6, 2007

Related U.S. Application Data
(60) Provisional application No. 60/864,436, filed on Nov. 6, 2006.

(51) Int. Cl. H04N 7/10

(52) U.S. Cl. 725/32

(57) ABSTRACT

A distributed video advertisement marketplace is disclosed. The system enables one or more intermediary systems to access the video templates and functionality of a remote system by using remote procedure calls. A remote system responds to these remote procedure calls with an appropriate remote procedure call response. The intermediary system may be a web server and it may be accessed by a client system by using a web browser. The intermediary system may present a customized user interface to the client system that matches the look and feel of the rest of the content on the intermediary system. The user may purchase a video advertisement using an electronic commerce form.

### CROSS REFERENCE TO RELATED APPLICATIONS

This application claims benefit to provisional application 60/864,436, filed on Nov. 6, 2006, which is incorporated by reference herein in its entirety.

### FIELD OF THE INVENTION

The present disclosure relates to systems for creating video advertisements. In particular, the disclosure relates to software for the creation and distribution of customized video advertisements over a network.

### BACKGROUND

The Internet and the spread of computing devices such as notebook computers and mobile phones have changed the nature of advertising substantially. In the past, advertising was limited to printed materials, radio, and television ads. These advertisements were not highly targeted and were often unavailable to all except the most wealthy clientele. National advertising has since become more accessible, and now even small businesses can advertise directly to their target audience's computing devices via the Internet.

There are several commercial entities that distribute advertisements over networks such as the Internet. For example, Google's “Adwords” service allows business owners to distribute various forms of advertisements to potential customers who browse the Internet. These advertisements are targeted so that when a potential customer searches for a keyword relevant to a particular business, that business's ad will be presented to the potential customer.

The cost of producing a video advertisement has also traditionally been prohibitive. Video editing tools, such as video editing software, have become more accessible. Examples of video editing software include Windows Movie Maker, Macromedia Flash, and Apple's Final Cut software. However, this kind of software is often complex, and costly camera equipment may be required to produce a video of high enough quality so that it is effective for advertising. Many business owners simply do not have the prerequisite computing skills or finances to produce an effective video advertisement. A system that enables a user to easily create a video for advertising is desired.

While systems exist that provide targeted advertisements distributed over a network, video advertising remains inaccessible to the vast majority of business owners. An improved and more accessible network advertising system is desired.

### SUMMARY OF THE INVENTION

A video customization system is disclosed that allows the user of a client system (the client) to easily create a customized video advertisement. A client system accesses a remote system through a network, and is presented with a graphical user interface (GUI). The client may select a video from a variety of preset video templates, or may upload his or her own video for modification in the system. The GUI allows the user to input a variety of textual advertising information and upload audiovisual overlays. A renderer on the remote system applies the audiovisual overlays to the video template to create a customized video advertisement. The system also allows the user to utilize a large variety of special effects, which may be applied to specific audiovisual overlays, a portion of the video, or the entire video.

A Distributed Video Advertisement Purchasing System is disclosed. The system enables one or more intermediary systems to access the video templates and functionality of a remote system by using remote procedure calls. A remote system responds to these remote procedure calls with an appropriate remote procedure call response. The intermediary system may be a web server and it may be accessed by a client system by using a web browser. The intermediary system may present a customized user interface to the client system that matches the look and feel of the rest of the content on the intermediary system. The user may purchase a video advertisement using an electronic commerce form.

### BRIEF DESCRIPTION OF THE DRAWINGS

The present invention is illustrated by way of example and not limitation in the figures of the accompanying drawings, in which like references indicated a similar element in accordance with an aspect of the invention.

FIG. 1 is a network diagram showing the interaction of a client system and a remote system to produce a customized video advertisement, according to an embodiment of the invention.

FIG. 2 is a flow chart that demonstrates the creation of a customized video advertisement using a preset video template, according to an aspect of the invention.

FIG. 3 is a flow chart that demonstrates the creation of a customized video advertisement using a user-uploaded video, according to an aspect of the invention.

FIG. 4 is a network diagram of a Distributed Video Advertisement Purchasing System, according to an embodiment.

FIG. 5 is a graphical user interface that allows the client to input advertising information and audiovisual overlays, according to an embodiment.

FIG. 6 is a graphical user interface that allows the client to input audiovisual overlays and effects into a timeline panel, according to an embodiment.

FIG. 7 is a graphical user interface that allows a client to select a video advertisement category, according to an embodiment.

FIG. 8 is a graphical user interface that allows a client to preview a video template prior to purchase or editing, according to an embodiment.

FIG. 9 is a graphical user interface that allows a client to preview a video template prior to purchase or editing, containing links to related video templates, according to an embodiment.

FIG. 10 is a flow chart describing the process of creating a customized video, according to an embodiment.

FIG. 11 is a flow diagram for an advertisement creation and delivery system, according to an embodiment.

FIG. 12 is a screen shot illustrating a user list, according to an embodiment.

FIG. 13 is a screen shot illustrating a list of ad categories, according to an embodiment.

FIG. 14 is a screen shot illustrating a list of ad sub-categories, according to an embodiment.

FIG. 15 is a screen shot illustrating different available ads for a particular sub-category, according to an embodiment.

FIG. 16 is a screen shot illustrating a campaign configuration, according to an embodiment.

FIG. 17 is a screen shot illustrating a further campaign configuration, according to an embodiment.

FIG. 18 is a network diagram showing a video advertisement distribution system, according to an embodiment.

FIG. 19 is a network diagram showing a video advertisement distribution system wherein the video advertisements are distributed using an IPTV system, according to an embodiment.

### DETAILED DESCRIPTION

The term “audiovisual”, as it is used in this application, is not to be construed as exclusively referring to a combination of audio and video. The term may be used to refer an audio element, a visual element, or a combination of the two. The term “audiovisual overlay” therefore refers to any audio or graphical overlay, or to an overlay that is a combination of audio and graphical elements.

The term “network”, as it is used in this application, should be construed broadly to cover any network of two or more linked computing devices. The network could be, for example, the Internet. It could also be a local area network (LAN), a wireless local area network (WLAN), wide area network (WAN), or global area network (GAN). Any of these and other types of networks may be employed to practice the systems and methods disclosed in the present application.

The term “client” shall refer to any user of a “client system” 100, 400.

The terms “customized video” and “modified video” are used interchangeably and refer to the video that is produced by the renderer (see operations 212, 226) according to an embodiment.

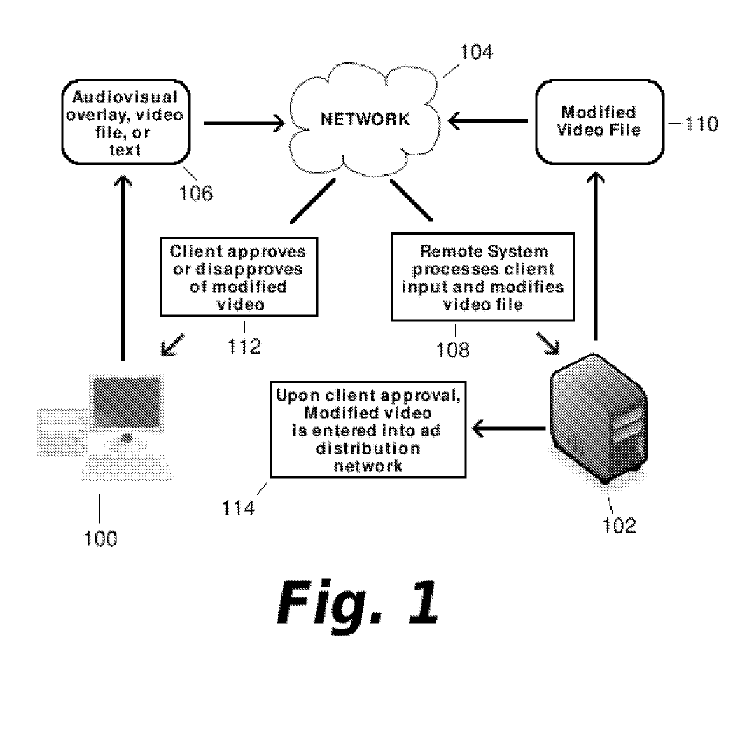

FIG. 1 illustrates a highly abstracted network diagram of a video customization system according to an embodiment of the invention. A client system 100 engages in the transfer of data with a remote system 102 through a network 104. The client system 100 may be any computing device. However, the client system 100 will typically be a personal computing device, such as a desktop computer, notebook, mobile phone, or a personal digital assistant (PDA). The client system 100 will typically be running an operating system such as a Windows or Linux distribution, Solaris, or any other operating system. In some embodiments, the remote system 102 is a web server. The remote system 102 will also have an operating system. The operating system on the remote system 102 could be any operating system, but usually it will be an operating system designed specifically for servers, such as Windows Server 2003 or a Linux distribution. There are many solutions for implementing a web server, and any such solution falls within the scope of the present disclosure. The remote system 102 need not be a web server at all, and could be any other kind of server capable of transmitting data and performing the functions of any embodiment disclosed herein.

The data that the client system 100 submits to the remote system 102 is encapsulated in block 106. The data may include an audiovisual overlay, video file, text, or other data. This information can be used by the remote system 102 in operation 108 to create a modified video file 110. If the user of the client system 100 disapproves of the final product in operation 112, the client has the option of repeating operation 106 by transmitting more data to the remote system 102. This data may include corrections or modifications to data already transmitted. The remote system 102 will then produce a new modified video file based on input from the client system 100 and the process will be repeated until the user of the client system 100 indicates approval of the modified video. The video may then be entered into an advertisement distribution system 114.

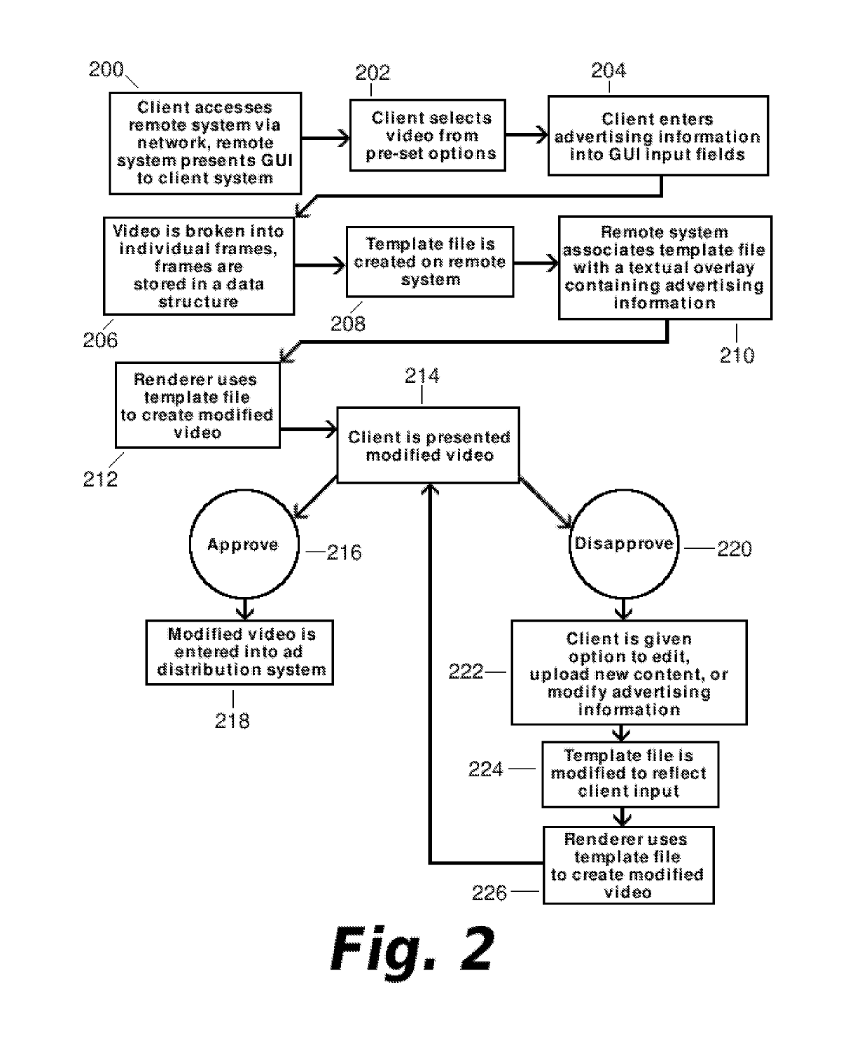

FIG. 2 illustrates a process flow diagram which shows a client's typical interaction with the system according to an embodiment. At operation 200, a client accesses a remote system 102 via a network. This may be accomplished by using a web browser such as Firefox, Internet Explorer, or Opera, on the client system 100. However, if the remote system 102 is not a web server, then other appropriate software may be used by the client system 100. In an exemplary embodiment, the client system 100 utilizes separate software exclusively designed to operate in conjunction with the remote system 102. In some embodiments, the client can create an account on the remote system 102, and this will be associated with any data that the client transmits to or generates on the remote system 102, such as audiovisual overlays or video files.

Also at operation 200, the client is presented with a graphical user interface. In an exemplary embodiment, this graphical user interface (GUI) is presented to the user as an Hypertext Markup Language (HTML) document, which is rendered in the client system's 100 web browser to present the client with an interactive user interface. However, the user interface could also be stored in a local storage medium on the client system, such as a hard drive, and accessed when the client runs software to be used in conjunction with an embodiment. The user interface may be presented using solely HTML, or it may be a combination of HTML and scripting languages. The scripting languages used may be client-side scripting languages such as Javascript and Flash Actionscript, server-side scripting languages such as PHP, ColdFusion, or Ruby on Rails, or any combination of server and client-side scripting languages. In an exemplary embodiment, a client-side Actionscript-driven GUI is presented to the user. When the client submits information or files using the GUI, a server-side scripting language, such as PHP, may be used to acquire and store the client-submitted data on the remote system 102.

In operation 202, the client has accessed the GUI and has been presented with a series of pre-selected videos. In an exemplary embodiment, these videos are organized by product or service category. Each product or service category may have sub-categories, and those sub-categories may themselves may have sub-categories, and so on. This type of categorization will allow clients to quickly “drill down” to the desired product or service category. This categorization may be implemented through HTML hyperlinks, client-side scripting, or any other method. When the client reaches the most relevant category, he or she will be presented with thumbnails of one or more video templates to choose from. Upon clicking on these thumbnails, the client will be able to preview the video in order to gauge whether this is the video that he or she would like to customize.

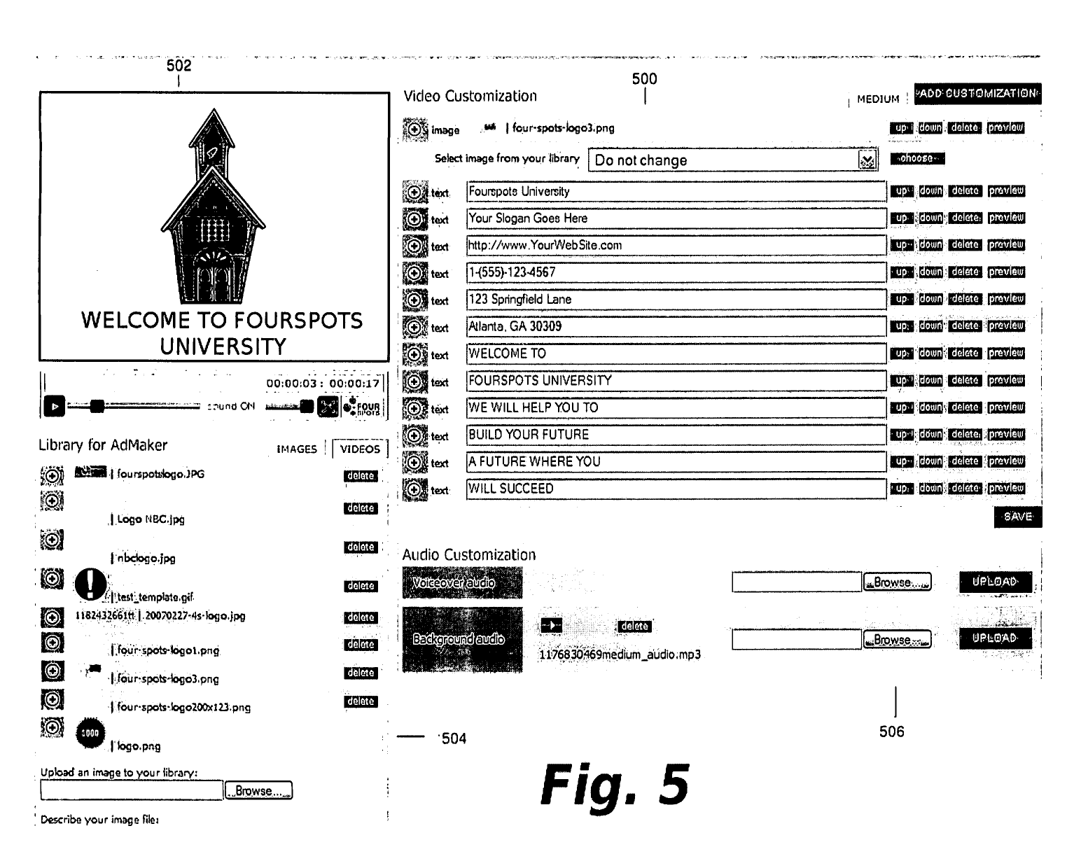

In operation 204, the client enters advertising information into the GUI. An exemplary embodiment of this portion of the GUI is illustrated in FIG. 5. The advertising information may consist of the business name, phone number, e-mail address, advertising slogans, or any other type of textual information that the client would like to be presented in the video advertisement. This information may be entered, for example, using a text input panel 500. In some embodiments, the text input fields are labeled in the GUI are labeled to increase user-friendliness of the system. For example, a field where the client is to enter his or her business's name would be labeled “Your Business Name:”. When the client has finished entering the advertising information into the GUI, the client can interact with the GUI to indicate completion. This may be accomplished by clicking on a button with a label such as “go” or “submit” using a mouse or other peripheral connected to the client system 100. When the client does this, the advertising information can be transferred to the remote system 102 using a server-side scripting language such as PHP, or other methods. The advertising information will then be stored in the memory of the remote system 102. If the user has failed to fill out a critical field or has otherwise committed an error, error-checking algorithms implemented in either client-side or server-side scripts can block the data from being submitted to the remote system 102, inform the client of the error, and direct the client back to the appropriate GUI screen in order to correct the error. Once the client has successfully completed filling out the advertising information, the information will be transmitted to the remote system 102 via a network 104 and stored in the remote system's 102 memory.

In operation 206, the remote system 102 begins the process of inserting the advertising information submitted by the client into one or more textual overlays in the selected video. This may be accomplished a number of different ways. In some embodiments, each frame of the video is converted into an image file, and each image file is stored in a data structure such as an array. However, the data structure could be in the form of a linked list, stack, queue, tree, or any other data structure. In some embodiments, the image format is one well suited for video images such as jpeg, but the images could be in any format.

In operation 208, a template file is created on the remote system 102. The template file is what the remote system 102 uses to create a modified video file 110. The template file may itself contain the audiovisual content to be overlaid on a video or may simply contain references to the location(s) in memory of audiovisual overlays to be inserted into a modified video. In some embodiments, the template file is a database element that associates audiovisual overlays with frame locations in a video. In other embodiments, the template file is an XML file containing references to the memory location of audiovisual overlays accompanied by a reference to the frame(s) in a video where those overlays are to appear. The template file may take these and many other forms, and will contain the information regarding audiovisual overlays and the point(s) in a video where the audiovisual overlays are to appear. In some embodiments, each preset video that may be selected by a client has its own preset template file located on the remote system 102 which designates appropriate points in the video where textual overlays containing the client-submitted advertising information should be presented.

At operation 210, the remote system 102 creates textual overlays based on the advertising information submitted by the client and modifies the template file to reference those overlays 1008. The textual overlay can be converted to an image prior to rendering the modified video, or it may simply be stored as textual data in the template file or in a separate text file. In either case, information about the font, duration, effects, and other presentational data may be associated with the textual overlay. This presentational data may be stored in the template file, the same file as the textual overlay, or an entirely separate file. The insertion point of these textual overlays can be preset in the template file for convenience. However, the client is not bound by these preset insertion points and may modify them using the GUI.

At operation 212, a renderer on the remote system 102 utilizes the template file to produce a modified video file 1012. The renderer is a process on the remote system 102 which synthesizes all the data from the template file, audiovisual overlays, and video data into a customized video. The renderer may be implemented a variety of different ways. According to one embodiment, the renderer can iterate through the template file data and combine the referenced elements and image array to stitch together a new, modified video frame-by-frame. In some embodiments, this is accomplished using a software library such as FFMPEG to combine the audiovisual overlays and video data. The output video file can be in any format and the renderer may easily be modified to output any video format that the client or service-provider desires. In some embodiments, the renderer may accept as a parameter the desired type of output file. The renderer can also be implemented using a client-side scripting languages such as Actionscript.

It is desirable, of course, to utilize an output format that is widely used so as to optimize compatibility with diverse systems. The Macromedia Flash SWF format is a widely used format and compatibility with this format is standard on Windows, Macintosh, and Linux systems. Accordingly, in some embodiments the output file for the modified video can be an SWF file. The renderer is also capable of modifying the size and quality of a video. Multiple versions of the video, varying in size and quality, may be stored on the remote system 102 and presented to the client system 100. This is done because the computing devices that ultimately receive the video ads can receive them with varying degrees of video quality and/or bandwidth. For example, a mobile phone user may have less bandwidth available than the user of a desktop computer with a fiber-optic connection. The advertisement distribution system may therefore provide a large video to the desktop user and a small video to the mobile phone user. In some embodiments, the client may be able to preview how each of these different-sized videos will appear prior to their entry into the ad distribution system.

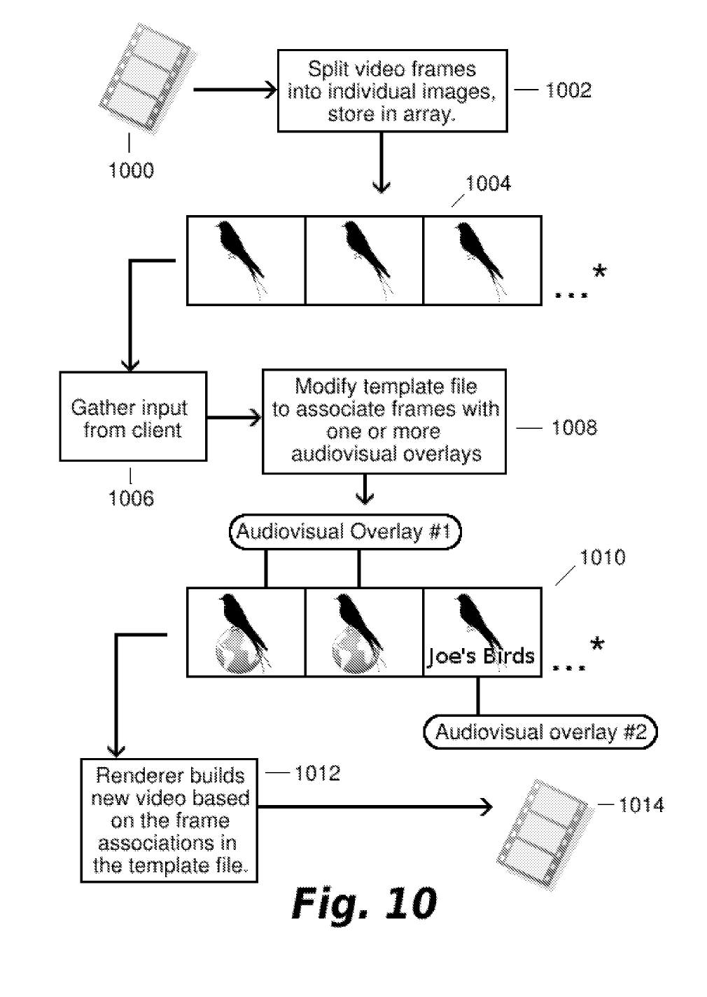

FIG. 10 illustrates the video customization process, according to an embodiment. An original video 1000 is stored in memory on a remote system 102 or a client system 100. This process may be repeated multiple times until the client is satisfied with the customized video 1014. When the process is repeated, the customized video 1014 may re-enter the process as the original video 1000, or the client may choose to discard the customized video 1014 and proceed again using the earlier original video 1000. In operation 1002, the original video's 1000 video frames are split into individual images and stored in an array 1004. Element 1004 is an abstract conceptual model of an array according to an embodiment—it does not represent how the data array will actually appear as in the system. The array could also be replaced with any other data structure, such as a linked list. This particular array 1004 contains three frames with an image of a bird on each frame. However, the frames may contain any image and there may be any number of them.

At operation 1006, input will be gathered from the client. This can be done using any of the GUI's shown and described in this disclosure or any other method. The input may consist of audiovisual overlays such as image files, video files, or audio files, or it may comprise textual data which the system can convert to an audiovisual overlay. The input may also consist of data indicating the portion of the video in which an audiovisual overlay is to appear. In operation 1008, the input gathered in operation 1006 is used to modify a template file, which associates frames with one or more audiovisual overlays. Element 1010 demonstrates conceptually how the template file can link one or more audiovisual overlays to the frame data in a video. In this example, a globe (audiovisual overlay #1) is associated with the first two frames of the video, while some text (audiovisual overlay #2) is associated with the third frame. It is important to note that any individual frame or groups of frames can be associated with multiple overlays. At operation 1012, the renderer builds a new customized video 1014 based on these associations, and the video 1014 is returned to the client for approval. The original video 1000 and customized video 1014 may be in any format, including AVI, MPEG, WMV, SWF, or any other video format.

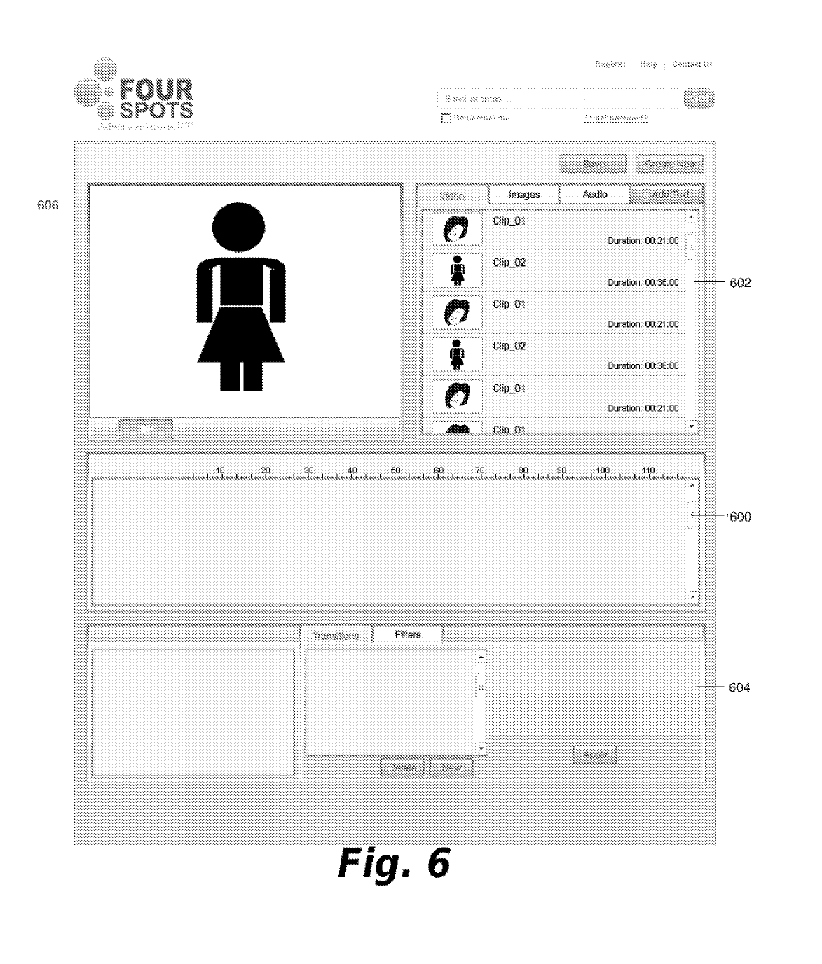

At operation 214, the remote system 102 transmits a customized video file to the client system for preview. The client may spend as little or as much time as he or she desires creating a customized video advertisement. For convenience, textual overlays containing the advertising information are easily placed in the final video simply by entering that information into the GUI in operation 204 (see FIG. 5). However, the GUI also allows the client to create a highly customized video by uploading his or her own audiovisual overlays (see FIG. 5, FIG. 6). These could be, for example, image files, audio files, or textual data. They could also be interactive SWF objects or vector objects. This gives the client complete control over the customization of the video. These options are represented in operation 222, but can also be performed at operation 204.

After previewing the video, the client will either approve 216 or disapprove 220 of the video. If the client disapproves 220 of the customized video, he or she will be given the option make changes to the video in operation 222. A client's disapproval 220 need not be explicit; after viewing the modified video, the client may immediately engage in more editing. A client's disapproval 220 can be explicit too, however. For example, an “Are you sure?” dialog window may be presented to the client prior to approval 216 and a negative response would indicate disapproval 220. An exemplary GUI screen for operation 222 can be seen in FIG. 6. It should be noted that disapproval 220 is not a necessary prerequisite to access the editing options of operation 222. These editing options may be made available to the client at the outset of the process, such as after operation 202 or 300, or at any other relevant time that the client may reasonably desire to access this portion of the interface.

FIG. 6 illustrates an exemplary graphical user interface (GUI) that the client may utilize to customize a video. A timeline panel 600 displays a graphical representation of the placement of audiovisual overlays in a particular video. The timeline panel 600 may include frame increments, time increments, a combination of the two, or any other data relevant as a guide for overlay placement. An overlay display panel 602 shows the overlays that are currently available to the client. The client may augment the overlays available by uploading audiovisual overlays to the remote system 102. An overlay may be added to the timeline panel 600 by dragging and dropping an element from the overlay display panel 602 to the timeline panel 600, by right-clicking an overlay element and accessing an “add” dialog, or through a variety of other methods. Changes to the video may be processed immediately upon transfer of an element to the timeline, or they may require user action, such as clicking an “apply” or “submit” button to take effect. Once the changes in the timeline take effect, the client may preview the modified video in the preview window 606.

An effects panel 604 may be used to apply effects to specific audiovisual overlays or to portions of the entire video. For example, the client may specify that a series of frames will fade in, or a textual overlay may be given a “fly in” effect causing the text to fly in from the left and explode to a final size and color at a specified time or frame number. The effects engine employs a substantial number of effects which can be combined to produce a truly unique video advertisement. The effects may be added by selecting a portion of the video from the timeline panel 600, then interacting with the effects panel 604 to apply an effect to the selected portion. The selected portion may include one or more audiovisual overlays, portions of audiovisual overlays, entire frames, or a series of frames, or any combination thereof.

If the client approves 216 the customized video, the process is complete. The video is stored on the remote system 102 and may be distributed to other computing devices via an ad distribution system. The customized video, along with any textual data or audiovisual overlays that the client has uploaded, will be associated with the client's account information on the remote system 102. If the client decides to further modify the video, he or she need only log in to the remote system 200 and resume the editing process 214, 220, 222, 224, 226.

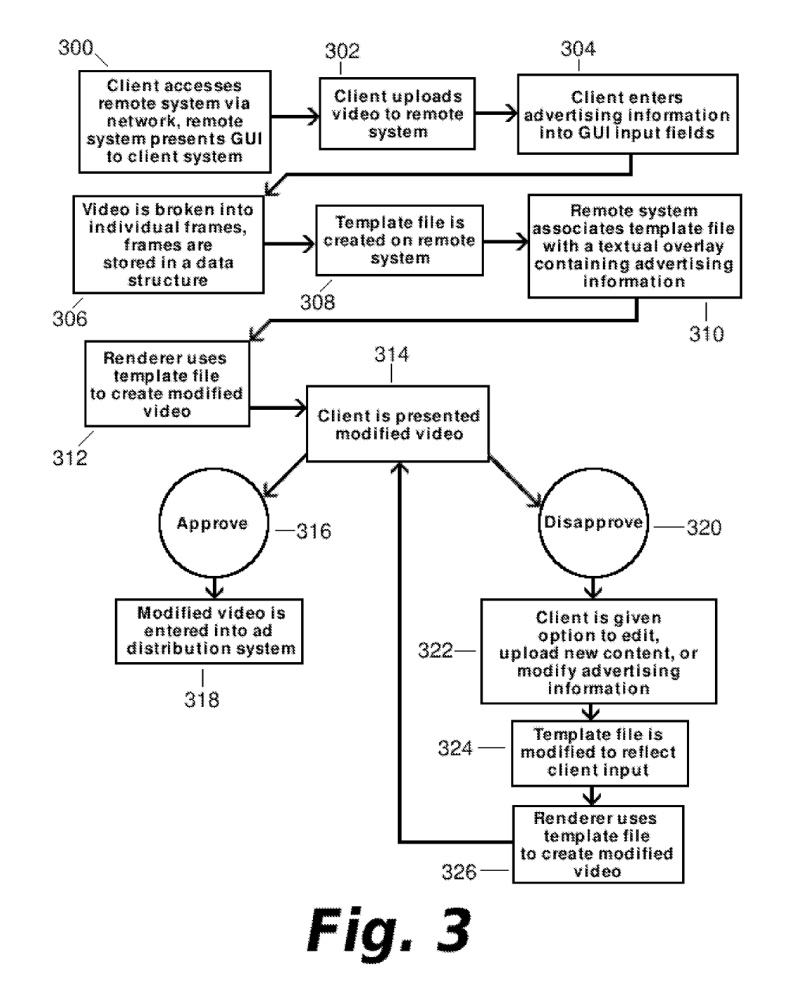

FIG. 3 illustrates a process flow diagram which shows a client's typical interaction with the system according to an embodiment. The chart is the same as the chart in FIG. 2 except in this interaction the client does not choose one of the preset video templates. Instead, in operation 300 the client uploads his or her own video to the remote system 102. All of the same editing options are available when the client uploads his or her own video as when the client chooses a preset video. The client may wish not to use any editing options of the at all and instead proceed straight to the ad distribution system 218. Sometimes the video file format the client has chosen may differ from those supported by the advertisement distribution system. If this is the case, conversion to a supported format may be performed automatically, or the client may be presented with a dialog GUI to choose which supported format to convert to and to optimize the conversion. The client also has the option of uploading a video in a supported format at the outset and in that case format conversion will not be necessary. The format conversion may be performed on the remote system 102 or the client system 100 using a software library such as FFMPEG or any other software library or program suited for that purpose.

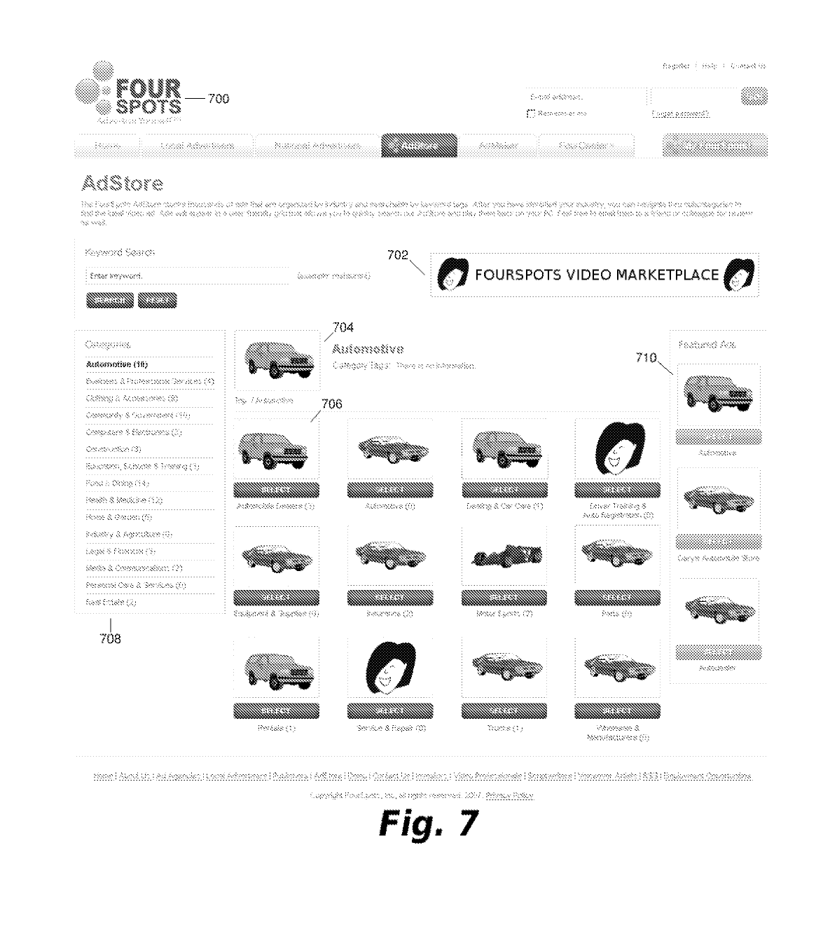

FIG. 7 illustrates the GUI of an advertisement store according to an embodiment. As discussed previously with regard to operation 202, several categories of video templates 706, 708 are presented to the client. The client may then “drill down” to find an appropriate video. In some embodiments, the advertisement store may be implemented on a separate system that acts as an intermediary between the client system 400 and the remote system 402. This intermediary system may belong, for example, to a partner or affiliate of the remote system 402. The intermediary system 406 can access all the functionality (including video customization) and content of the remote system 402 through remote procedure calls (RPCs). The intermediary system 406 may also simply re-direct the user to establish a direct connection with the remote system 402 at any point in lieu of a remote procedure call 410. The remote procedure calls could be, for example, SOAP (Service Oriented Architecture Protocol) or API (Application Programming Interface) requests and responses. To the client, it will appear as if the Intermediary system is the same as the remote system 402; all the operations in the flow charts in FIGS. 2-3 will function the same way to the client system 400; there will simply be an intermediary system 406 presenting the GUI to the client system and transferring data between the client system 400 and remote system 402. In this way, an intermediary system 406 may provide all the video customization functionality of the remote system 402 while preserving aesthetic consistency with other interfaces, such as other web pages, that may be transferred to the client system 400 by the intermediary system 406. A remote procedure call response 412 will be returned by the remote system 402 in response to the remote procedure call 410. This response 412 can take a variety of forms, such HTML code for displaying a series of video templates, a customized video file, payment confirmation, or an error message.

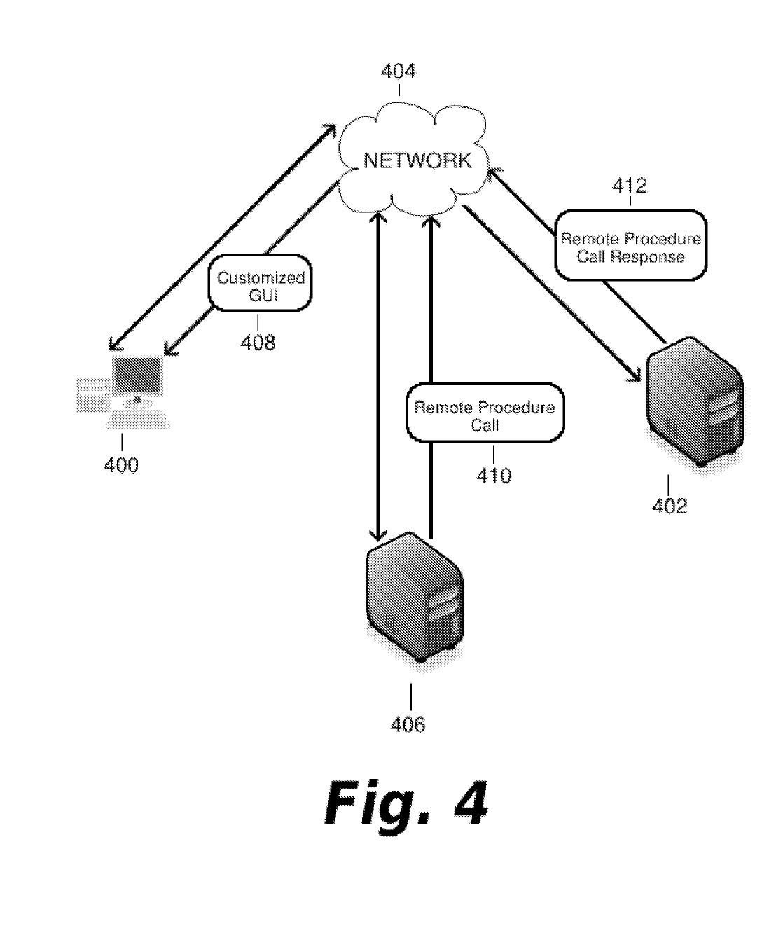

FIG. 4 illustrates a network diagram of a distributed advertisement purchasing system, according to an embodiment. A client system 400 communicates with an intermediary system 406 via a network 404. In some embodiments, the intermediary system 406 is a web server. The initial communication from the client system 400 to the intermediary system 406 may be, for example, and HTTP (hypertext transfer protocol) request. The intermediary system 406 will then transfer a customized GUI 408 to the client system 406. This customized GUI may include content acquired from the remote system 402 using a remote procedure call 410. This content may include but is not limited to video templates, video editing interfaces, streaming video and audio data, electronic commerce forms, graphics, and text. The distributed advertising system may include multiple intermediary systems 406 which access a common remote system 402 using remote procedure calls. These intermediary systems 406 may be accessible by multiple client systems 400.

The intermediary system 406 will often be owned and operated by a different entity that the remote system 402. The intermediary system 406 will therefore be afforded some control over how the advertisement store is presented to the client system 400. For example, the intermediary system can present the client system with an advertisement store with a similar color scheme to other portions of the system's website, if the intermediary system 406 is a web server. The intermediary system 406 may also offer customized video template options; the intermediary system 406 is not necessarily restricted to a the selection of customizable video templates that are offered by the remote system 402. These exclusive video templates may be stored on the remote system 402 or on the intermediary system. In this way, intermediary systems may use video templates specific to that intermediary system. Intermediary systems may also contain common, non-exclusive video templates, which may be stored on the intermediary system 406 or the remote system 402. In some embodiments, there are a plurality of intermediary systems 406 that are accessible by a plurality of client systems. The intermediary systems 406 may use varying implementations of the advertisement store, accomplished by utilizing remote procedure calls. In some embodiments, the differences in implementation between these intermediary systems will be mostly cosmetic in order to blend in with the hosting website or network service. These changes will often involve modification of color schemes and the insertion of site-specific banners, logos, and trademarks into the GUI. Aside from these cosmetic differences and the presence of different video templates, the intermediary servers may offer client interaction that is equivalent to the exemplary flow charts of FIGS. 2-3 as described earlier, the only difference being that remote procedure calls made by the intermediary system 406 are used to pass data between the remote system 402 and the client system 400.

FIG. 7 illustrates an exemplary GUI 408 that may be presented to a client system 400 by an intermediary system 406. An intermediary system may provide a customized logo 700 using an image file stored on the intermediary system 406, or uploaded to a remote system and accessed using a remote procedure call. The logo 700 need not be an image file and could be, for example, an SWF object. Customized banners 702 may also be used. Any portion of the graphics, color scheme, or layout may be customized to provide a unique look to the advertisement store. An intermediary system 406 may offer its own exclusive video template categories 706, 708 or they may present preset categories acquired from the remote system 402 using a remote procedure call 410.

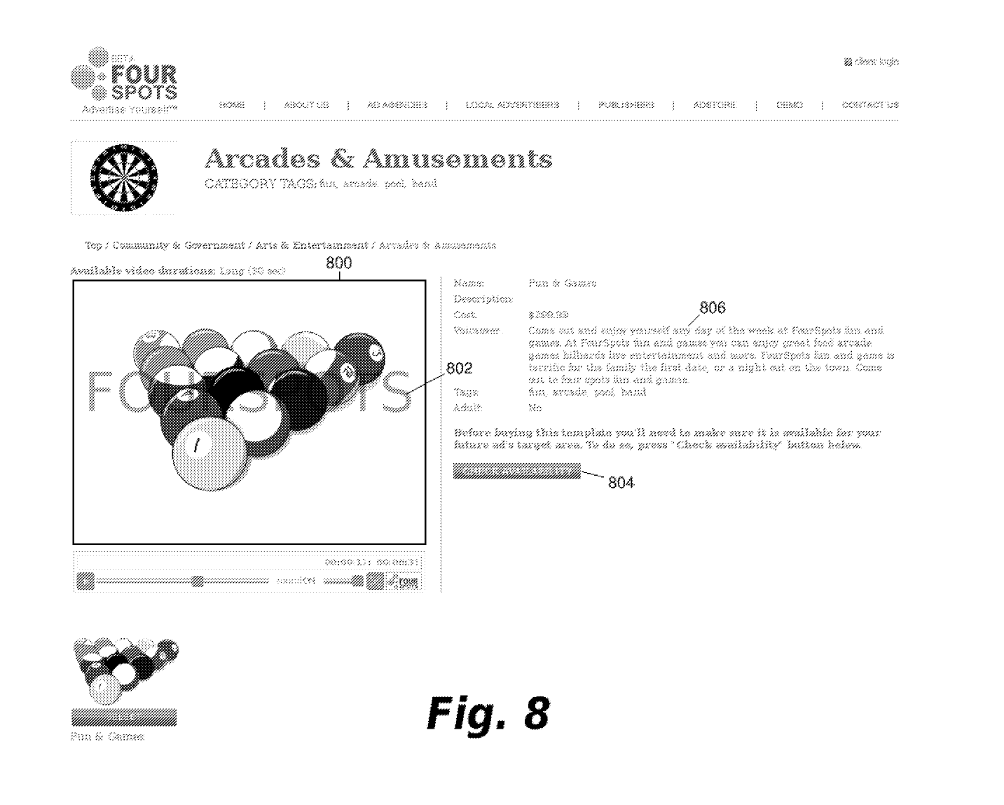

FIG. 8 illustrates another exemplary GUI 408. This particular GUI may be presented to the client after drilling down and selecting a video template or template category. A preview of the template may be played in a preview window 800. The user may customize the audio played during the video by modifying the text used for the voice-over 806. The text will be converted to an audio file using text-to-speech software, and then inserted in the video as an audio overlay. The system allows a client to check the availability of a particular template using a “check availability” button 804. Certain templates may not be available to local advertisers if a competitor or other business is already using that template in the client's geographic area. Also, a template may not be available if the advertising distribution system does not provide advertisements to the geographic region. This functionality allows a client to determine whether he or she will be able to use the template prior to spending time editing and creating a customized video advertisement.

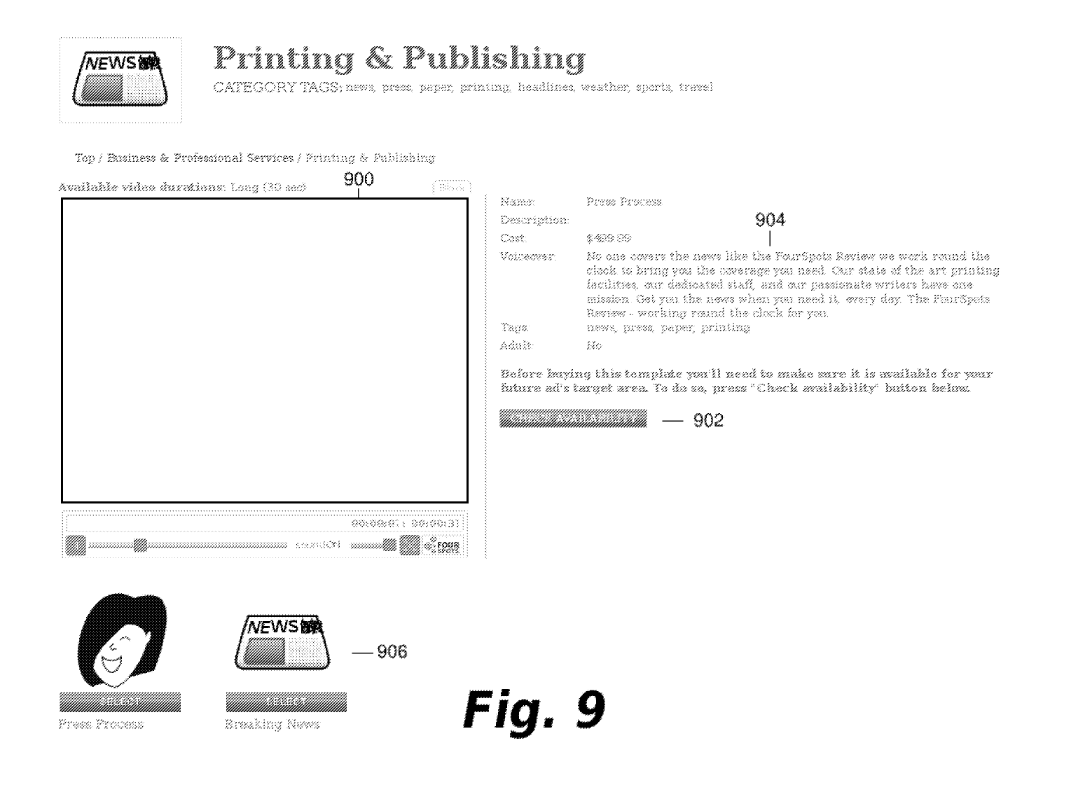

FIG. 9 illustrates another exemplary GUI 408. This GUI may also be presented to the client after selecting a video template or category. Other templates 906 in the category may be linked to in the GUI using thumbnails. This enables the client to easily browse through related video templates.

Payment may be accomplished in the advertisement store through interaction with an electronic commerce form presented through the GUI. The payment GUI may be integrated with the remote system and accessible through RPCs 410 via the intermediate system 406. Payment may also be directly processed by the intermediary system without the need for an RPC. Payment may be required at any step of the process, though normally it will occur either after the selection of a preset video from the advertisement store or after the client has finished editing a video to his or her satisfaction. For example, a payment screen may be presented after the user clicks “check availability” 804, 902. In order to prevent unlawful use of the advertisement store to create a video advertisement without payment, a watermark 802 may be added to all previews of the video until payment is received. Once payment is received, the watermark 802 may be removed and the client may distribute the video advertisement using an advertisement distribution system. The advertisement store may be adapted to be displayed on any computing device, including but not limited to laptops, personal digital assistants, cellular phones, and desktop computers.

An online ad generation system is used to automate a process of creating ads. Ads can be video ads with voice-overs which can be distributed across any computer communications network such as the Internet.

Ads need to be created using human resources, such as videographers, voice-over artists, actors, etc. However, the process of allowing all of the human elements to collaborate in order to create ads can be automated using an online ad generation system.

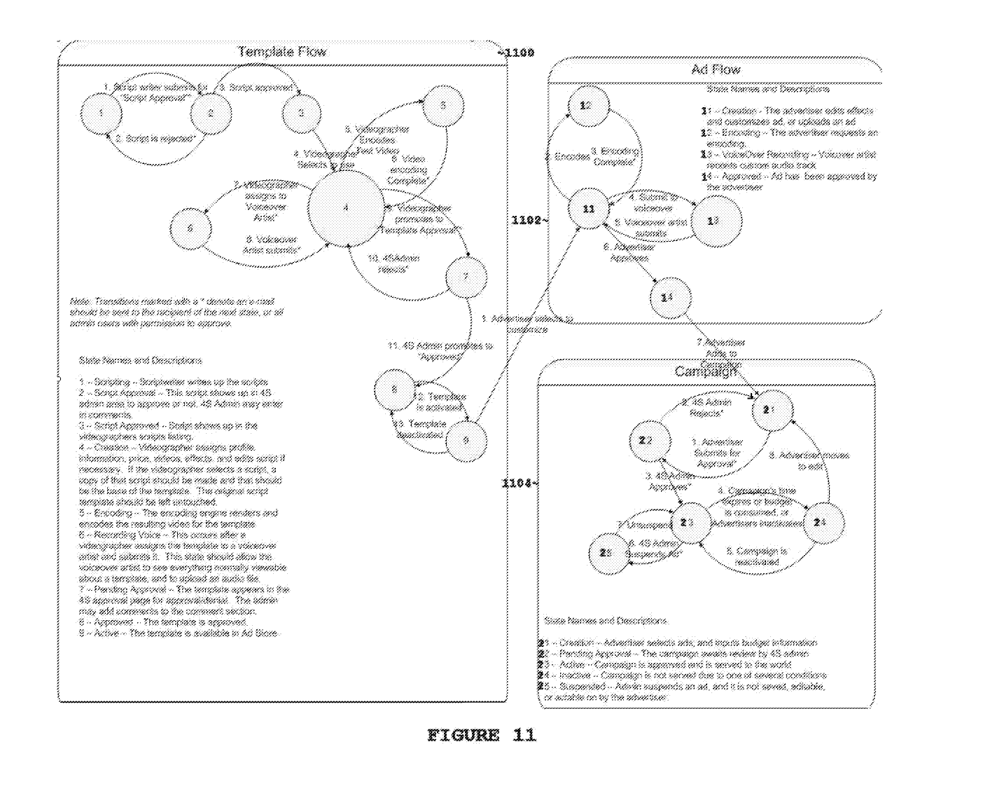

FIG. 11 is a flow diagram for an advertisement creation and delivery system, according to an embodiment. All transactions illustrated herein can be accomplished using a database(s)/server(s) with transmissions being carried out over a computer communications network (e.g., the Internet).

There are three components to ad generation and delivery: 1) template flow, 2) ad flow, and 3) campaign. The template flow relates to the creation of a generic template, which is a video ad which uses generic names in the audio and text in the ad. For example, a generic ad template for a pizza parlor might use “acme pizza” in the audio and display “acme pizza, 555-1234, 2 oak street, Springfield, 11111” which is a placeholder telephone number and address. The placeholder telephone number and address is used because the real user of the ad is not known yet. At a later point in time, the real user of the ad (e.g., “Joe's Pizza”) will be able to use a voice over to add audio which says “Joe's Pizza” on the ad and will be able to change the placeholder information to the actual name “Joe's Pizza” and address for Joe's Pizza. This process of replacing placeholder information with real information will be discussed below in more detail.

A potential advertiser can view a plurality of templates (which are actual video ads using placeholder information) and choose which one they like.

Ad flow relates to the process of turning a generic template into an actual customized ad. The placeholder information (both in audio and video) is replaced with the actual information of the party purchasing the ad.

Campaign relates to the delivery of the video ad to an audience. Typically, ads are delivered in a targeted fashion so that viewers fitting a particular demographic will be served particular ads.

A first operation to generate a template comprises a scripting 1 operation. A scriptwriter can write the script for an ad. An ad can be any length, for example can be 15 or 30 seconds (or any other length). A scriptwriter is free to choose any type of ad for any type of product or service the scriptwriter wishes. The scriptwriter can write a script and submit it into the system.

Once a script is submitted it is then passed to the approval process 2. During the approval process, a party with approval authority (such as the system administrator) can review the script and approve or deny it. If the script is rejected, then it is sent back to the original authors. If the script is approved, then the process proceeds to the script approved operation 3. In the script approved operation, the script now shows up in a videographers' listing of potential scripts. A list of approved scripts is compiled by the system and can be viewed by videographers. Videographers can review the list of approved scripts and choose one that the videographer decides to film.

Thus, from operation 3, the method can proceed to creation operation 4, wherein the videographer(s) creates the video ad using the script he or she has chosen.

Once the videographer has filmed the ad, the method can proceed to operation 5, which encodes the video ad that the videographer has filmed. The encoding operation 5 comprises transmitting the video content to a server and converting the video content to a format (e.g., flash, MPG, etc.) that the system can read and distribute. The video content (ad) is also indexed and stored by the server so that it can be retrieved and displayed at a later point in time.

After the video ad is filmed, a voice-over artist is needed. The actors in the ad can speak and this audio is stored with the video ad. Additionally, a voice-over artist can be used to speak over the ad as well. Typically, the voice-over artist is not physically present in the video ad and thus there is no concern about the voice-over artist having to physically appear in the video. The voice-over artist at this point will speak their part and use placeholder information (because the end purchaser/user of this ad is not known yet).

Thus, from operation 4, the method can proceed to operation 6, which records a voice-over on the ad. The videographer can choose which voice-over artist the videographer wishes to use (e.g., by reviewing a list of voice-over artists and samples of each of their work). In operation 6, the ad and script is sent to the chosen voice-over artist, who records the voice-over and transmits the voice-over to the server. Thus, the ad template for this particular ad is now complete (a “complete ad”). However, this ad uses placeholders (e.g., generic identifiers (i.e., “ACME”) in text in the video as well as the audio, since the ad has not been purchased by an advertiser yet.

The ad template can now be designated as having “approved” status by the videographer, upon which a system administrator can then accept or reject the ad template. If the template is approved, then the template is activated and the method can proceed to operation 9 which makes the template available in the ad-store. The ad store displays available templates for purchase by advertisers. If the template is rejected, then the videographer will have to review comments by the administrator as to why the template was rejected and can then modify the ad template (e.g., redo voice-overs, video, etc.) so that the videographer can try again to have the template approved.

Once a template is approved, an advertiser can select the particular template to use (the template can be free or must be purchased, depending on the embodiment being implemented). The method can thus proceed to operation 11, wherein the advertiser customizes the template (ad) tailored to the advertiser's own company.

The customization would entail encoding the advertiser's own information in operation 12. This entails replacing the placeholder text in the template (e.g., “ACME pizza”) with the actual name of the advertiser and any other advertiser specific information (e.g., address, phone number, prices, etc.)

The customization would also entail using a voice over artist to record a custom audio track for the ad. This would replace the audio placeholder (e.g., “ACME”) with audio containing the advertiser's real name and other information. The voiceover artist, in operation 13, would record the particular audio for the ad and transmit the recording to the server.

Once the voice-over is recorded and the actual text used is encoded into the ad, the ad is complete and the advertiser can review as to whether to approve or not. If the advertiser approves the ad, the method can proceed to operation 14 which changes the status of the ad to approved. If the advertiser does not approve, the advertiser is free to make whatever changes he or she wishes to the add (e.g., re-doing the voice over or encoding, etc.)

Once an ad is approved by the advertiser, the ad still has to be approved by the system administrator. Thus, in operation 21, the advertiser submits the ad for approval. In operation 22, the system administrator reviews the ad. If the ad is rejected, the ad is returned to the advertiser and the advertiser can review comments by the system administrator as to why the ad was rejected.

If the system administrator approves the ad, then the method can proceed to operation 23 wherein the ad is deemed active and can now be served. The advertiser can also choose to suspend the ad which would proceed to operation 25 which suspends the ad which means the ad is not served until the advertiser changes the status. The advertiser can also unsuspend the ad at the advertiser's choice.

The ad campaign's budget may also expire (or other conditions) which can cause the ad to have “inactive” status in operation 24. The campaign can be reactivated (e.g., more money is added, etc.), upon which the ad status then can change back to active (operation 23).

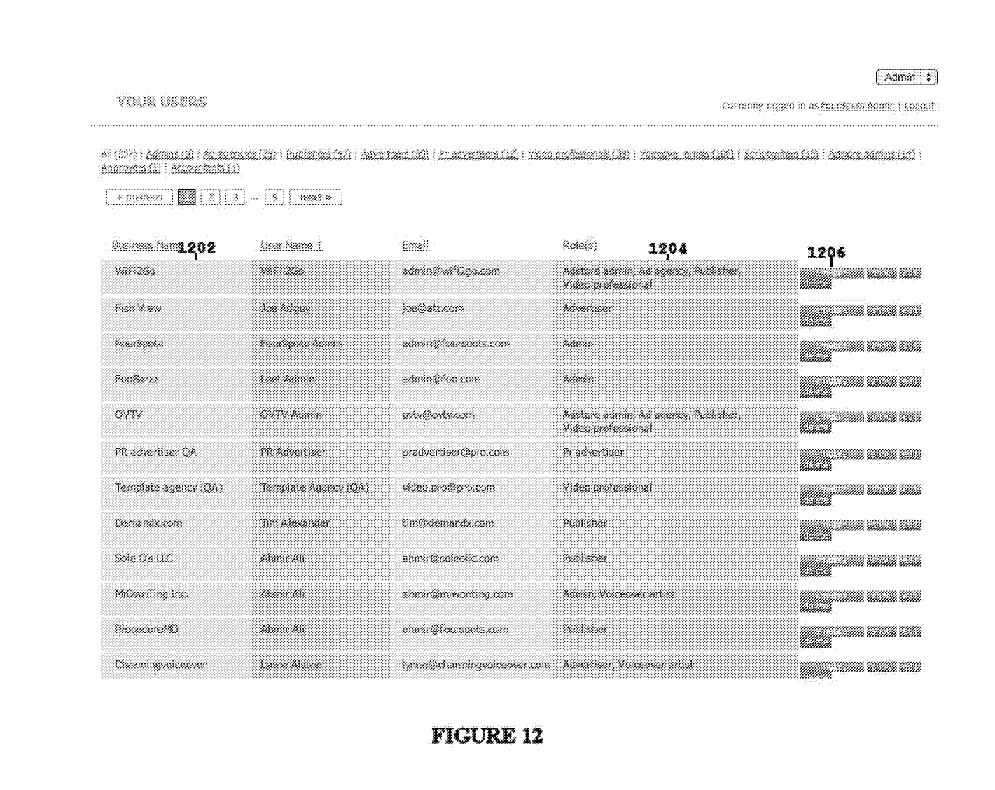

FIG. 12 is a screen shot illustrating a user list, according to an embodiment.

A business name column 1202 lists a series of users (business names) that can be signed in. There are roles on the top of the screen shot indicating various roles that users can take on. Users can be an administrator (admin) which can have power to approve of scripts, ads, and other aspects of the system. Users can also be publishers, which are owners or operators of web sites which will display ads created using the system. Users can also be advertisers, which are companies which generate their ad (as described herein) in order so that it can be published and served on publishers' web sites. User's can also be video professionals, which can be videographers which film scripts. The video professionals can be paid for their efforts. The users can also be voiceover artists which speak the voice-overs in order to generate ads, as described herein. Users can also be scriptwriters who write scripts for ads, who are typically paid for each script they write that is approved.

A role column for each user name 1204 displays each user's respective role. A button column 1206 displays buttons that can be used to sign in as each user. The person signing in will typically have to enter a password to authenticate himself or herself.

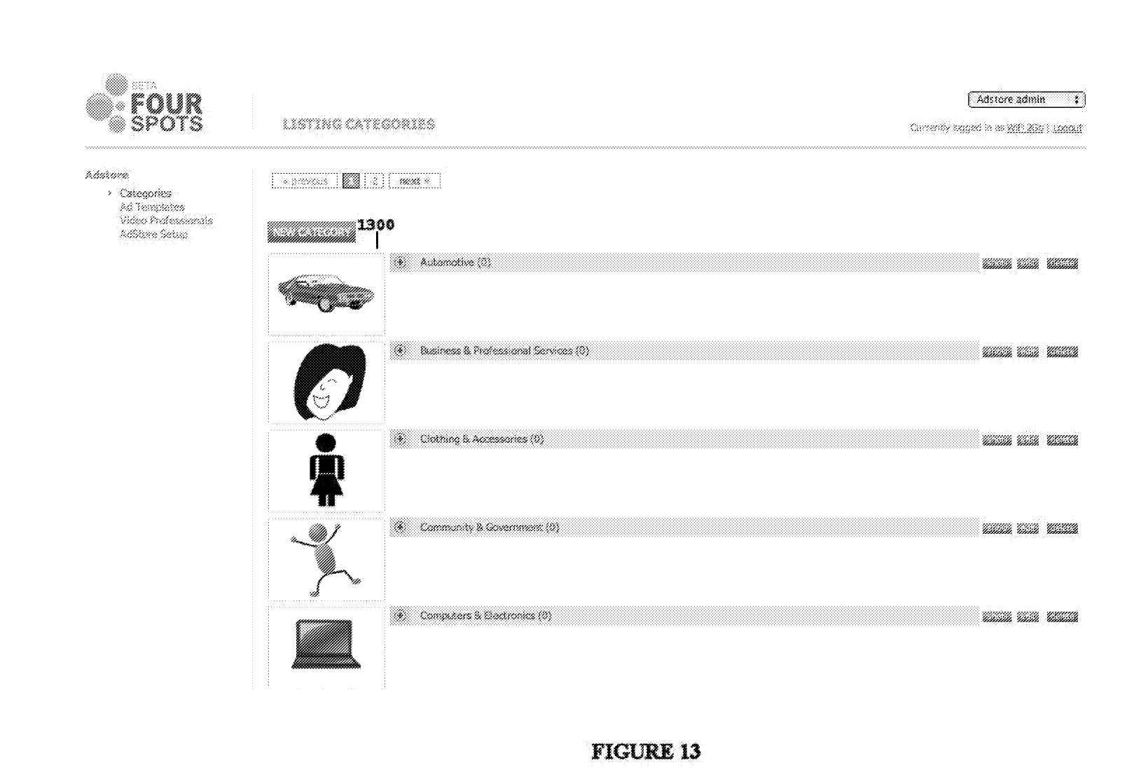

FIG. 13 is a screen shot illustrating a list of ad categories, according to an embodiment.

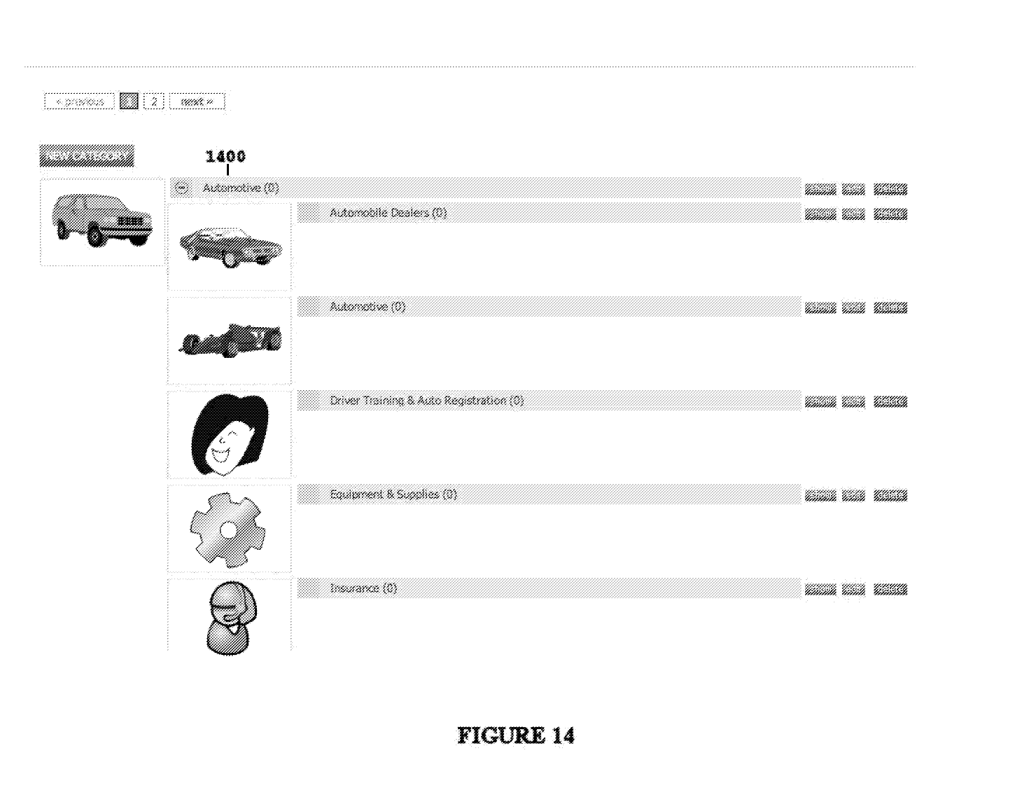

A user can also display a category list 1300 of ad types. Example categories of ads shown include automotive, business and professional services, clothing and accessories, community and government, and computers and electronics. A user can click any of these categories, for example, automotive, which will bring up the automotive category as illustrated in FIG. 14.

FIG. 14 is a screen shot illustrating a list of ad sub-categories, according to an embodiment.

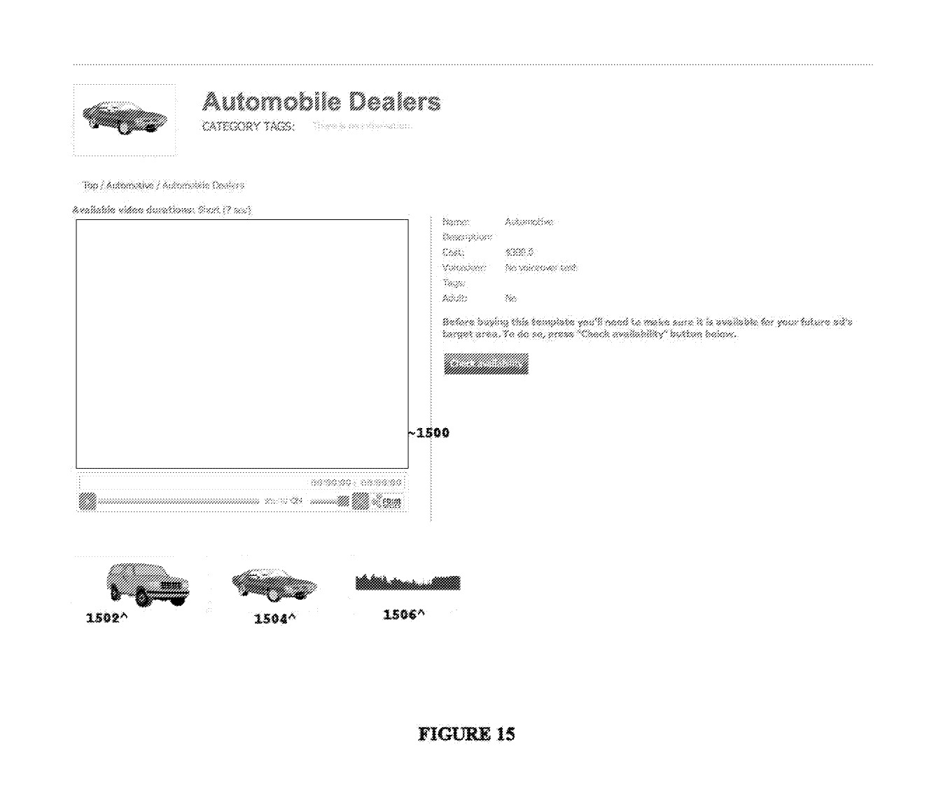

A subcategory column 1400 displays subcategories of ads for the automotive category. Examples of subcategories include automobile dealers, automotive, driver training and auto registration, equipment and supplies, and insurance. Each of these subcategories are types of automotive businesses. A user would typically click the subcategory for the type of business that the user owns, so that a list of ads for that subcategory can be brought up. For example, if the user is an automobile dealer and clicks automobile dealers, then the system will display FIG. 15.

FIG. 15 is a screen shot illustrating different available ads for a particular sub-category, according to an embodiment.

A current ad 1500 (shown as black) will play (audio and video) so that the user can see this ad and decide if he or she wishes to purchase it. Additional ads 1502, 1504, 1506 are displayed which the user can click to display as well. The user can press a purchase button (not pictured) if the user likes the current ad being displayed and wants to purchase it. Once an ad is purchased, then operations 11-14 from FIG. 11 can be performed to generate a complete ad, which can then be processed according to operations 21-25 of FIG. 11.

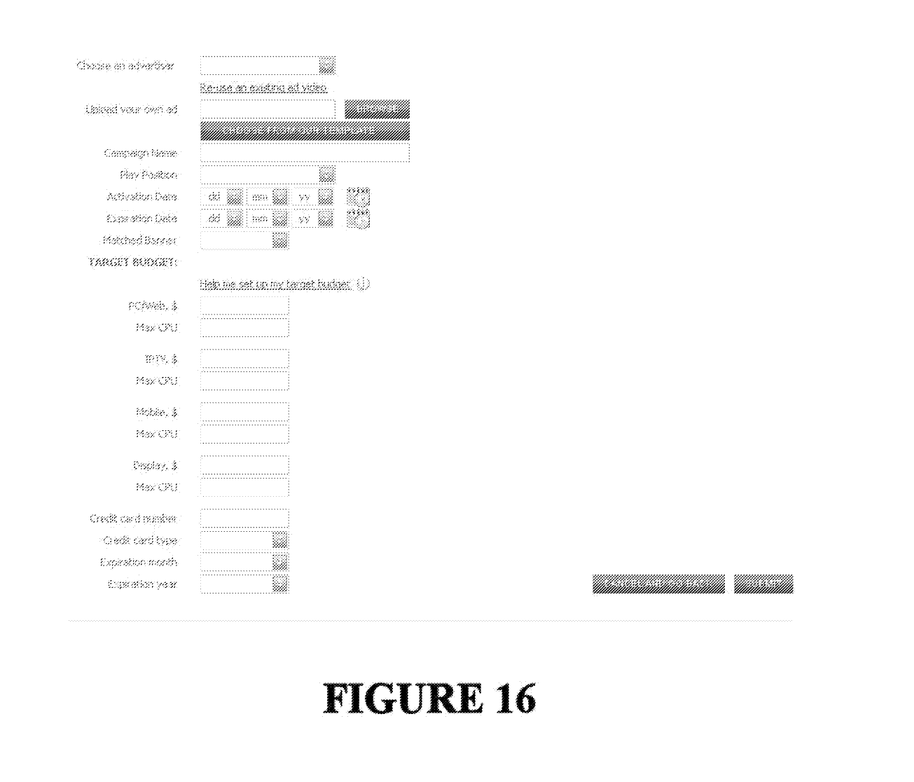

FIG. 16 is a screen shot illustrating a campaign configuration, according to an embodiment.

The advertiser can enter parameters such as the date/times the ad should be active, the budget for the ad, a maximum cost the advertiser is willing to pay for each serving of the ad.

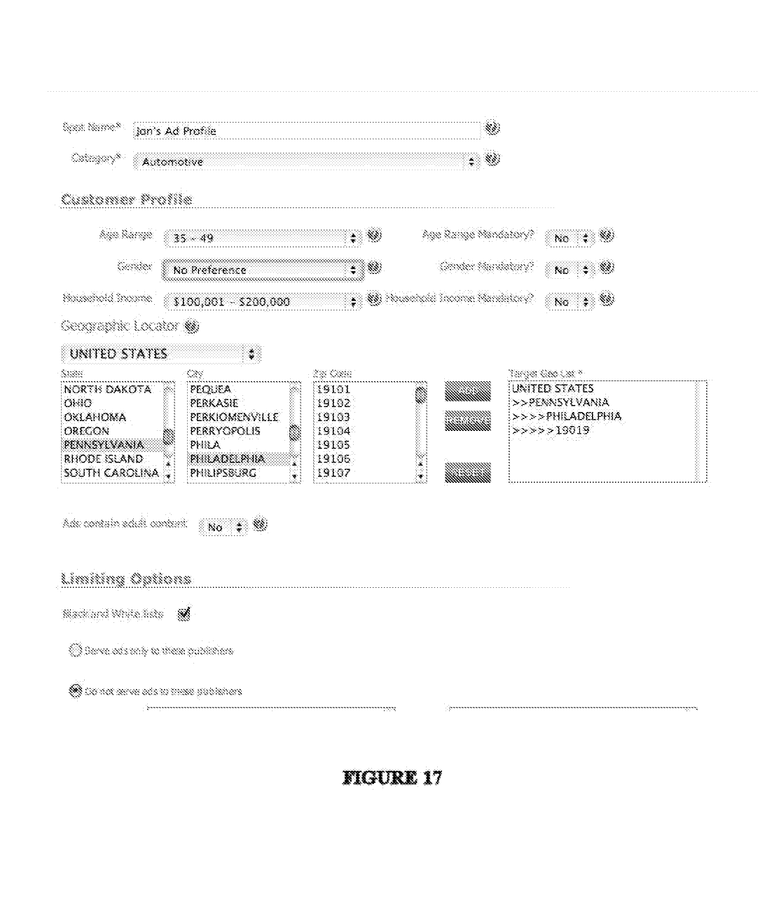

FIG. 17 is a screen shot illustrating a further campaign configuration, according to an embodiment.

The advertiser can select attributes that a user must possess before the ad will be served to them. For example, the advertiser can select a household income of viewers (parties that will be served the complete ad). In this example, the household income is set at between $100,001-$200,000. Thus, if a potential viewer's household income falls outside this range, they will not be served the particular ad for this set of attributes. The advertiser can also set the viewers' age range, gender, geographic location, etc.

An example of the system described herein will now be presented. John is a script writer. He decides to write a script for an ad for a pizza parlor.

Jack is a videographer. Jack looks through many scripts online and likes the script written by John and decides to film it. Thus, Jack files the ad shows a family eating pizza and enjoying their dinner according to John's script. At the end a voice announces “ACME pizza parlor is the best” and displays the following in text, “ACME pizza parlor, 3 oak street, (555) 555-1234”. The ACME name, address, and phone number are placeholders, since the ultimate advertiser isn't know yet. Jack has created a generic template using John's script.

In one embodiment, Jack pays a fee to John (e.g., $30) to be able to use John's script. In an alternative embodiment, Jack pays nothing to John now but John can get paid by Jack when Jack's generic template is actually used by an advertiser.

Jill owns a pizza parlor and is looking for ads for pizza parlors. Jill searches the database and plays all of the generic templates for pizza parlors. Jill likes Jack's the best. In one embodiment, Jill can purchase the generic template for John's pizza parlor ad for a fixed price (e.g., $300). In another embodiment, Jill can pay nothing now to use John's pizza parlor ad but can pay John when Jill's complete ad is approved.

Once Jill has chosen to use Jack's generic template, Jill needs to generate a complete ad from the generic template. The complete ad will have the placeholders replaced with actual data for Jill's pizza parlor. Jill can electronically supply the database with the text needed for Jill's pizza parlor, e.g., “Jill's pizza parlor, 9 Broad Street, (555) 555-3333” (the real information for Jill's pizza parlor). This text can be displayed at the end (or at any time) during the complete ad.

Jill will also search the database for a voice-over artist. The database will list a plurality of voice-over artists, with their description and a sample of their work. Jill will choose a particular voice-over artist that Jill likes best, and the database/server will transmit a request to the particular voice-over artist (e.g., “Betty”). Betty will receive a script electronically indicating what to say. The particular voice-over artist can speak the voice-over part (the actual voice-over) into a microphone, the audio of which will be digitized and transmitted to the database and associated with the respective generic template.

The database will then take the original generic template, replace the placeholder text with the actual data (text or other graphics) and will replace the placeholder voice-over with the actual voice-over to create the complete ad. The complete ad no longer has any generic placeholder information but has the final information targeted to Jill's actual business.

Jill can now submit the complete ad to the database for approval, upon which the administrator(s) of the system will view the add and approve or deny it. Grounds for denial can be if the ad itself doesn't meet up to certain quality standards, may contain objectionable material, or any other criterion decided upon by the system administrators. If the complete ad is approved, the complete ad now has “active” status and can be served to end users through subscribers.

Jill indicates to the system her audience (targeted viewer) attributes, for example, geographic preferences, age, income, etc. These are criterion that are used to select users (viewers) that will be served the ad. If a user visits a particular web site, the web site may know the characteristics of the user using a number of methods (e.g., cookies, IP tracking, login information, etc.) If the user then meets the audience attributes (e.g., the user is within the proper age group, location, etc), the complete ad will then be served to the user through the web site the user is visiting. For example, if the user is visiting a particular web site about cars, the web site can have a window which shows a video ad which is targeted to the particular user and which the advertiser will be a cost for such ad to be displayed to the user.

Each time the complete ad is served to a user, Jill pays a predetermined amount (e.g., 10 cents per ad serving). While the ad is playing, a user can also click the window the video is playing in which will bring up the web site for the business itself (e.g., the web site for Jill's pizza parlor). If this happens, Jill can pay another predetermined amount (e.g., an additional 5 cents) when a user clicks the video window and brings up Jill's home page (the web page for Jill's Pizza Parlor).

If more than one ad meets the audience/viewer attributes for a user visiting a web site, then the ad served can be chosen randomly or ads can be cycled sequentially, or any other method can be used to distribute ads. Alternatively, if more than one ad has respective audience attributes that are met by a current user visiting a web site, then the ad that has a highest respective bid can be served. For example, advertisers can indicate their maximum cost to serve their ad, and actual ads chosen to be served can be chosen based on the highest bid.

Parties involved in the creates of each complete ad that is served can share in the revenue generated by receiving payment from the advertiser for each time the complete ad is served. This sharing can be accomplished in many ways. For example, consider a complete ad generated from a generic template which was written by a script writer, filmed by a videographer, and voice acted by a voice-over artist. Each time the complete ad is served, the videographer and/or the script writer and/or voice-over artist can receive a predetermined amount. For example, if the advertiser pays $1 for each time the complete ad is served, the script writer can receive 5 cents (or any amount), the videographer can receive 10 cents (or any amount), and the voice-over artist can receive 3 cents (or any mount). Thus, if the complete ad is served 100 times in a month, the advertiser will pay $100 for the month. The videographer would receive $10 for the month, the script writer will receive $5 for the month, and the voice-over artist will receive $3 for the month. The participants (script writer, videographer, voice-over artist) may also receive a fixed payment up front for their work (or may not, depending on the embodiment being implemented).

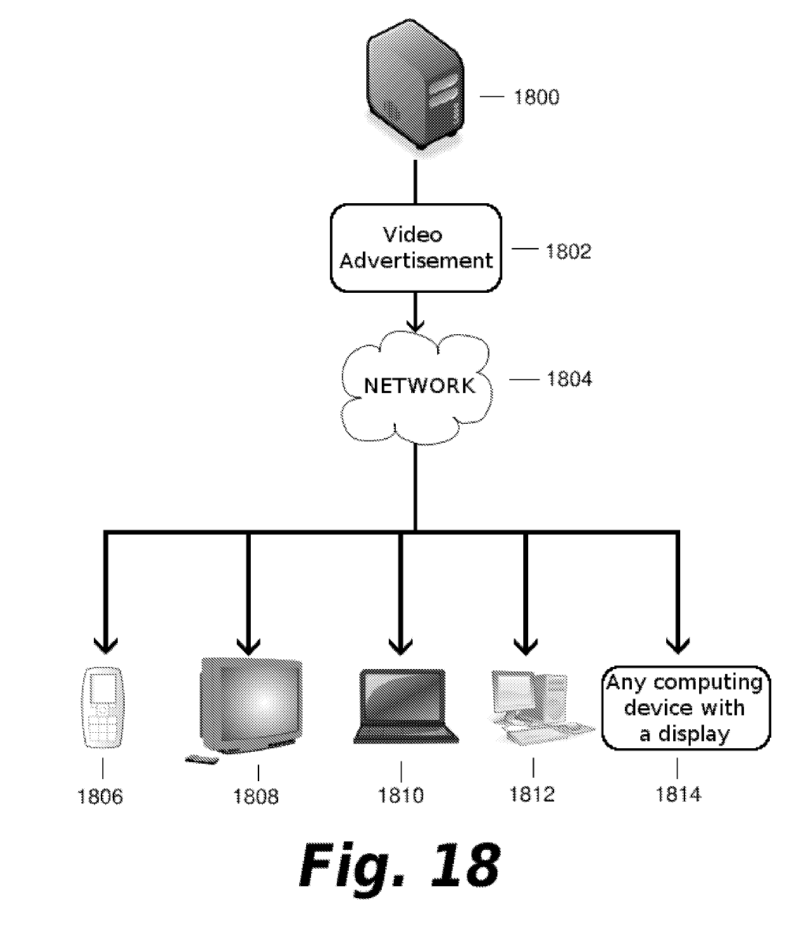

FIG. 18 is a network diagram showing a video advertisement distribution system, according to an embodiment.

A server 1800 can serve a video advertisement 1802 through a computer communications network 1804 (such as the Internet or other network). From the network 1804, the video advertisement can then be served (and displayed) to a variety of devices, such as a cell phone 1806, a television (outputting web content) 1808, a laptop 1810, a desktop 1812, or any other computing device 1814.

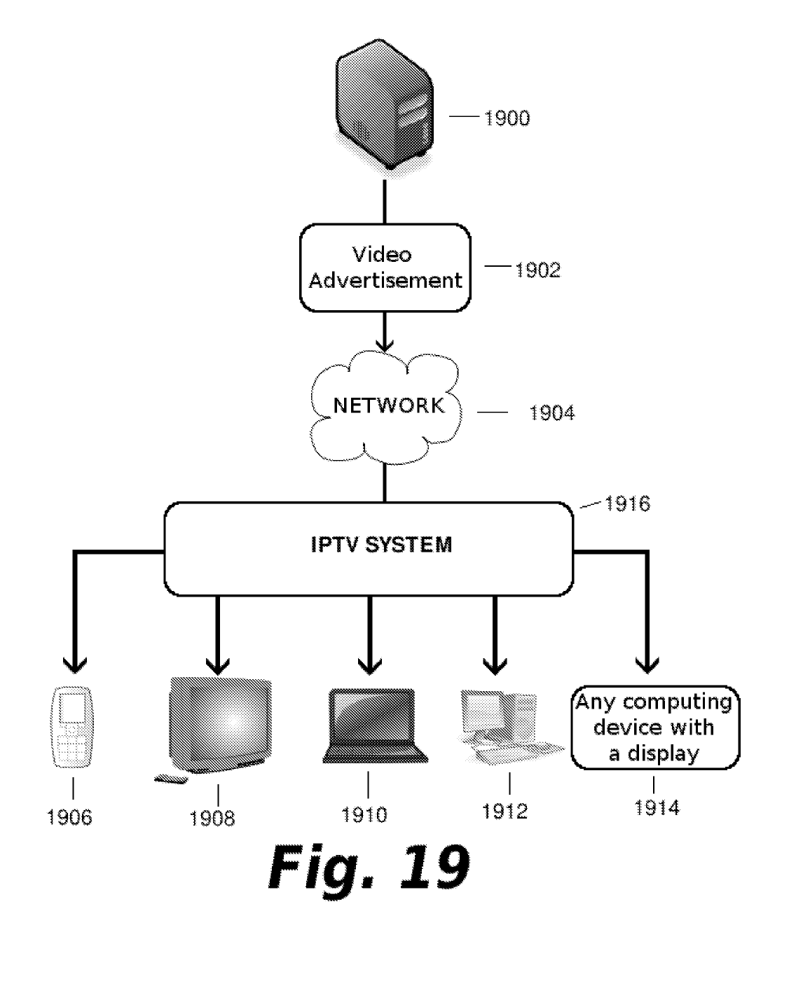

FIG. 19 is a network diagram showing a video advertisement distribution system wherein the video advertisements are distributed using an IPTV system, according to an embodiment. How to distribute targeted ads throughout an IPTV system is described in U.S. Pat. No. 6,771,644 and U.S. patent publication 2007/0244750, both of which are incorporated by reference herein in their entireties.

A server 1900 can serve a video advertisement 1902 through a network 1904 (such as a computer communications network 1904 or other network), which in turn sends the video advertisement through an IPTV (Internet protocol television) system 1916. From the IPTV system 1916, the video advertisement 1902 can then be served and displayed on a variety of devices that can display IPTV (or a related system) content, such as a cell phone (that can display IPTV or any other protocol) 1906, a IPTV enabled television 1908, a laptop (that can display IPTV) 1910, a desktop (that can display IPTV) 1912, or any other device 1914 that can be configured to display IPTV (or related system).

The inventive concepts described herein may be embodied in the form of computer-implemented processes and apparatus for practicing those processes. The present invention may also be embodied in the form of computer program code embodied in tangible media, such as digital versatile disk (DVD) read only memories (ROMs), CD-ROMs, hard disk drives, flash memories, floppy diskettes, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system for creating a customized video advertisement comprising:
a client system;
a remote system connected to a network and capable of transmitting and receiving data from the network;
one or more intermediary systems connected to the network and capable of transmitting and receiving data from the network, wherein the intermediary systems can access data and functions located on the remote system using remote procedure calls;
one or more client systems connected to the network and capable of transmitting and receiving data from the network; and
a graphical user interface that allows the user of a client system to select a video advertisement.

2. The system of claim 1 wherein the graphical user interface further comprises video templates transferred from the remote system to the intermediary system in a remote procedure call response.

3. The system of claim 1 wherein the graphical user interface further comprises one or more video templates exclusive to the intermediary system.

4. The system of claim 1 wherein the system further comprises:
a video customization system located on the remote system, the functionality of which is accessible through remote procedure calls made by the intermediary system.

5. The system of claim 1 wherein the intermediary system comprises a web server and the client system accesses the intermediary system using a web browser.

6. The system of claim 1, further comprising a purchasing application to perform purchasing a video advertisement through an electronic commerce form in the graphical user interface.

7. The system of claim 1, further comprising a watermarking application to add a watermark to the video advertisement.

8. The system of claim 7, further comprising a de-watermarking application to remove the watermark from the video advertisement after the video advertisement is purchased.

9. A method for marketing video advertisements comprising:
accessing an intermediary system by transmitting a request over a network;
presenting a customized graphical user interface to the user of a client system;
accessing the video templates of a remote system through a remote procedure call;
sending a remote procedure call response; and
presenting one or more video templates to the user.

10. The method of claim 9, further comprising:
purchasing a video advertisement through an electronic commerce form in the graphical user interface.

11. The method of claim 9, further comprising:
adding custom audiovisual overlays to the video template.

12. The method of claim 9, further comprising:
inputting advertisement information into the graphical user interface; and
adding a textual overlay containing the advertising information to the selected video.

13. The method of claim 9, further comprising:
entering the video into an advertisement distribution system.

14. The method of claim 9, further comprising:
uploading a video from the client system to the intermediary system.

15. The method of claim 9, further comprising:
Adding a watermark to a video template.

16. The method of claim 15, further comprising:
purchasing a video template; and
removing the watermark from the video template.

17. The method of claim 9, further comprising:
checking the availability of a video template.

18. A computer readable storage medium storing a computer program for marketing video advertisements, the computer readable storage medium controlling a computer to perform:
accessing an intermediary system by transmitting a request over a network;
presenting a customized graphical user interface to the user of a client system;
accessing the video templates of a remote system through a remote procedure call;
sending a remote procedure call response; and
presenting one or more video templates to the user.
